(19) United States
(12) Patent Application Publication
(10) Pub. No.: US 2001/0007310 A1
(43) Pub. Date: Jul. 12, 2001

(54) Flow deflector device

(76) Inventor: Tommy Chi-Kin Wong, Hong Kong (HK)

Correspondence Address: RABIN & CHAMPAGNE, PC, 1101 14TH STREET, NW, SUITE 500, WASHINGTON, DC, 20005, US

(21) Appl. No.: 09/731,770

(22) Filed: Dec. 8, 2000

(30) Foreign Application Priority Data
Jan. 6, 2000 (CN) 00201934.5
Apr. 27, 2000 (TW) 89206903

(51) Int. Cl. C02F 1/00

(52) U.S. Cl. 210/209

(57) ABSTRACT

The present invention relates to a flow deflector device for liquid treatment, more particularly, a tubular flow deflector device that includes a tubular shell and a through hole of certain diameter penetrating along the central axis line thereof. At least one spiral groove is provided along the inner wall of the tubular shell around the through hole. Thus the liquid flowing through the device can be sufficiently mixed for better effect of liquid treatment such as ultraviolet sanitation, water treatment, or temperature adjustment.

### BACKGROUND OF THE INVENTION

1. Field of the Invention

The present invention relates to a flow deflector device for liquid, more particularly, to a device for liquid (such as water) treatment. It is provided with at least one spiral groove inside in order to increase flow time so as to improve the effectiveness of water treatment, in the meantime, the liquid can be mixed evenly. It is an excellent device that not only can provide desirable effect of flow deflector but also lowered the cost.

2. Description of Prior Art

Generally speaking, the common way of liquid treatment is adding specific solute and solvent into the liquid, mixing homogeneously, adjusting temperature, and then sterilizing (such as ultraviolet irradiation), etc. The effect of treatment depends on whether the time for the treatment is enough or whether the liquid in the tube is evenly mixed. In other words, the degree of evenly mixing and the time for treatment are the two major factors for liquid treatment. The conventional flow deflector devices for liquid, however, are mostly tubular structure with no other special structure than a tube inside, only for water to flow. While treating liquid, this kind of structure allows water to flow through the internal channel directly. Whenever ultralviolet irradiation is applied inside or outside of the tube for sterilization, or the channel for liquid flow is cooled or heated for some purposes, since the liquid inside is not specially mixed, the sterilization, temperature adjustment and other treatment can not be effectively performed. What's more, while water flowing through the device of certain length, the time for water treatment is also insufficient to allow the liquid be evenly mixed. Therefore, the effect of water treatment is not desirable, which is the main drawback of the conventional device.

### SUMMARY OF THE INVENTION

It is the objective of this invention to provide a tubular flow deflector device, which includes a tubular shell and a through hole of certain diameter penetrating along the central axis line thereof. At least a spiral groove is provided on the inner wall around the of the tubular shell, around the through hole of the device. The spiral groove is extended along the central axis spirally that the liquid can be sufficiently mixed round while it's flowing. Also the time for water treatment is increased. The treatment, therefore, can be effectively performed, the liquid can be mixed more homogeneously as well.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 shows a perspective view of the present invention.

FIG. 2 is a schematic view showing the structure of the spiral groove.

FIG. 3 is a cross sectional view showing the way of operation of the flow deflector.

### DETAILED DESCRIPTION OF THE PREFERRED EMBODIMENT

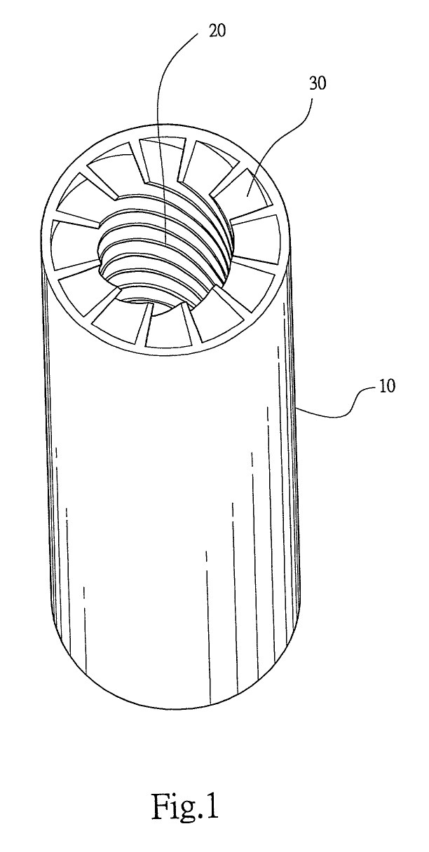

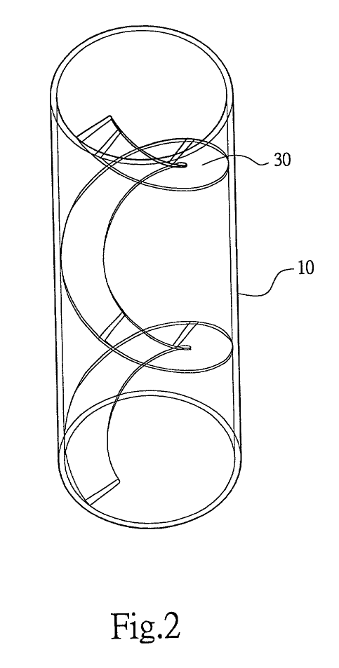

Referring to FIG. 1 and FIG. 2, the device comprises a tubular shell 10 that includes a tubular shell 10 and a through hole 20 of certain diameter penetrating along the central axis line thereof. At least one or several spiral grooves 30 are arranged along the inner wall of the shell 10, outside the through hole 20. The spiral grooves 30 wind round the inner wall of the tubular shell 10 longitudinally.

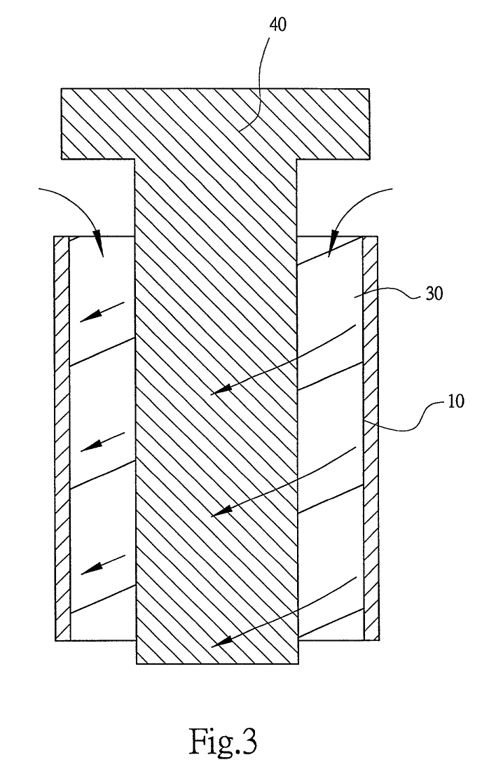

Referring next to FIG. 3, when the device is used, the tubular core reactant 40 for treating the liquid will be positioned into the corresponding through hole 20. The tubular core reactant 40 can be materials for filtering and purifying, ultraviolet sterilization lamps or temperature regulators. When the liquid, as the direction shown by the arrows, flows through the spiral groove 30, it rotates around the tubular core reactant 40 descendingly. As a result, not only the liquid can be thoroughly mixed inside the shell 10 by acentric force and the impact of rotation, but also the time for treating the liquid can be increased. In such arrangement, liquid treatment (such as ultraviolet sterilization, water treatment, and temperature adjustment etc.) can be effectively performed.

The novel invention has following advantages:

1. While liquid in the device flows through the spiral groove, it encircles around the tubular core reactant positioned in the center of the through hole so that the liquid can be sufficiently contact with the tubular core reactant thereof and can be more evenly treated.

2. As liquid flows in the device in a manner of circumrotation, it will be impacted by the rotation of acentric force. In this case, it can be well mixed. Furthermore, when the liquid rotates through the reaction axle core, the time for treatment will be prolonged, as a result, the liquid treatment can be effectively performed.

The invention has been described with reference to the preferred embodiments, it is appreciated that various modification to the inventive concepts may be apparent to those skilled in the art without departing from the spirit and scope of the invention. It is intended to include all such modifications and alterations insofar as they come within the scope of the appended claims or the equivalents thereof.

What is claimed is:

1. A flow deflector comprising a tubular flow deflector device, which includes
a tubular shell,
a through hole of certain diameter penetrating along the central axis line of said tubular shell for accommodating a tubular core reactant of water treatment,
one or several spiral grooves being arranged along the inner wall of said tubular shell, and winding around said through hole longitudinally for directing liquid therein flowing along said spiral groove in order to thoroughly mix the liquid and prolong the treating time of the liquid.
